(19) United States
(12) Patent Application Publication
(10) Pub. No.: US 2005/0225429 A1
(43) Pub. Date: Oct. 13, 2005

(54) Multiuser vehicle utilization system and electronic key therefor

(75) Inventor: Gianfranco Burzio, Orbassano (IT)

Correspondence Address: HOWREY LLP, C/O IP DOCKETING DEPARTMENT, 2941 FAIRVIEW PARK DRIVE, SUITE 200, FALLS CHURCH, VA, 22042-7195, US

(73) Assignee: C.R.F. Societa Consortile per Azioni, Orbassano (IT)

(21) Appl. No.: 11/083,818

(22) Filed: Mar. 18, 2005

(30) Foreign Application Priority Data
Mar. 30, 2004 (EP) 04425226.0

(51) Int. Cl. G08B 19/00

(52) U.S. Cl. 340/5.24; 307/10.5; 340/5.64; 340/5.31; 340/5.72; 701/49

(57) ABSTRACT

A vehicle utilization system permitting use of a vehicle (3) having a respective identification code (Cᵥₑₕ) includes a key (2) having a memory (5) for storing an enabling code (C_{id}) enabling use of the vehicle; and an enabling device (4) permitting use of the vehicle by a user in possession of the key, if the enabling code (C_{id}) stored in the key meets given conditions. The system also includes a programming device (12) for generating the enabling code (C_{id}) as a function of the identification code (Cᵥₑₕ) of the vehicle, and for storing the generated enabling code in the key (2).

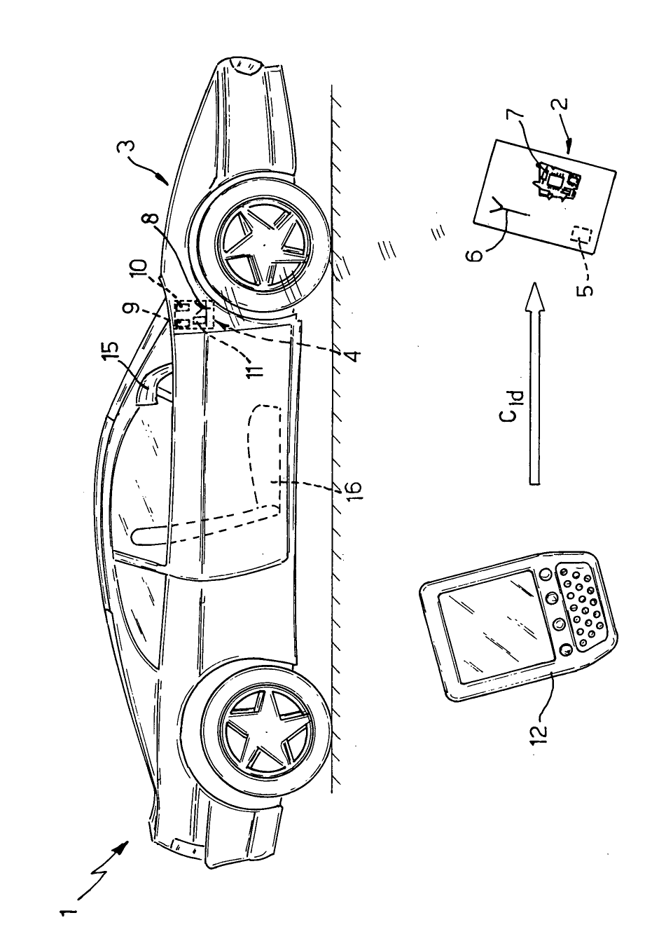

### BACKGROUND OF THE INVENTION

1. Field of the Invention

The present invention relates to a multiuser vehicle utilization system, and to an electronic key therefor.

2. Technical Background

Most vehicles currently feature conventional mechanical keys for access to the vehicle (unlocking and locking the doors) and turning on the engine, and which are normally associated with a door lock/release remote control.

Recently, more advanced vehicle utilization systems, based on radio-frequency identification devices, have been proposed for use either in conjunction with or instead of conventional mechanical key systems.

More specifically, such systems comprise a radio-frequency transmitter for transmitting an identification code, and an on-vehicle receiving unit which compares the incoming identification code with a code memorized on the vehicle. In the event of a match, i.e. positive identification, the system releases the vehicle doors, and may also enable other vehicle functions, such as starting the engine, which may be done, for example, by pressing a button or turning an ignition knob.

The identification code may be memorized in an electronic medium which may be combined with the radio-frequency transmitter to form an electronic key; and the electronic key may, for example, be in compact form, similar to a credit card, to be carried easily by the user.

In the case of vehicle fleets, such as company cars, hire cars and the like, the same vehicle may be used by various users, each with a respective key.

In this case, a table is memorized on the vehicle containing a number of identification codes, each for enabling a respective electronic key to permit use of the vehicle.

Other data, besides the user identification code, is also known to be memorized in the electronic key.

For example, data relative to different authorization levels governing use of a given vehicle is known to be memorized, so that the vehicle is only enabled, for example, for use during certain hours of the day, or for a limited mileage, or a limited number of days.

Another recent proposal is to memorized personal data in an electronic key, such as driver's seat, rearview mirror, car radio, or air conditioning settings, so that, by reading the personal data, the vehicle settings can be adjusted automatically in one operation.

All the above utilization systems are characterized by each key being assigned one identification code.

Consequently, the holder of an electronic key is only allowed access to a vehicle if the identification code of the electronic key is included in the code table memorized on the vehicle. Conversely, to enable use of the vehicle, the user must be supplied with another electronic key whose identification code is memorized in the on-vehicle code table.

Consequently, though in possession of a personal electronic key containing personal data relative to on-vehicle device preferences or settings, the user is unable to take advantage of them by having to use another key.

A demand is therefore felt for a vehicle utilization system designed to eliminate the drawbacks of known systems.

### SUMMARY OF THE INVENTION

According to the present invention, a vehicle utilization system and a key therefor are provided, as claimed in claims 1 and 16, respectively.

### BRIEF DESCRIPTION OF THE DRAWINGS

A preferred, non-limiting embodiment of the present invention will be described by way of example with reference to the accompanying drawing illustrating, schematically, a vehicle utilization system in accordance with the teachings of the present invention.

### DETAILED DESCRIPTION OF THE INVENTION

As shown in the accompanying drawing, a utilization system 1, in accordance with one embodiment of the present invention, comprises a portable electronic key 2 carried by a user wishing to use a vehicle 3; an enabling device 4 on vehicle 3; and a computer 12, e.g. a personal computer (desktop or laptop) or a PDA (Personal Digital Assistant). More specifically, computer 12 may preferably be in the form of a PDA already owned by the user.

Electronic key 2 comprises an electronic microprocessor circuit 7 associated with at least one memory 5 and with a known radio-frequency transmitter 6, which cooperate with electronic circuit 7.

According to one aspect of the present invention, memory 5 stores one or more enabling codes C_{id} (as explained in detail later on), and personal data Dₚₑᵣₛ relative to adjustable on-vehicle device settings, such as an automatic rear-view mirror 15, an automatic driver's seat 16, an air conditioning system, car radio, and satellite navigation system (not shown in the drawing). The personal data Dₚₑᵣₛ may also comprise the directory of an on-vehicle cellular telephone (not shown) or music in compressed digital format (e.g. MP3).

Personal data Dₚₑᵣₛ relating, for example, to adjustment of the driver's seat or rear-view mirrors may conveniently be indirect data, in the sense of relating to physical parameters of the user (such as height, arm length, etc.), so that the actual parameters by which to set adjustable devices on different vehicle models can be determined on the basis of the indirect data memorized in electronic key 2.

In one possible embodiment, electronic key 2 is in the form of a credit card, and is inserted in an electronic card reader (not shown) of computer 12.

In an alternative embodiment (not shown), electronic key 2 is in the form of a USB key, and is interfaced in known manner with computer 12.

On-vehicle enabling device 4 comprises an electronic circuit with at least a known receiver 8 for receiving the data transmitted by transmitter 6; a processing unit 9 for processing the incoming data; a comparator 10; and an actuator 11.

By means of dedicated software, computer 12 generates enabling codes C_{id}, and, when interfaced in known manner with electronic key 2, transfers them to memory 5 of electronic key 2, where the enabling codes C_{id} are stored.

The software may, for example, be developed by the maker of vehicle 3 and supplied to the user (e.g. in an optical medium) upon purchase of vehicle 3.

The basic idea of the present invention is that each vehicle 3 be assigned a single identification code Cᵥₑₕ, e.g. during manufacture or upon sale, and that the identification code Cᵥₑₕ be processed by computer 12 to generate an enabling code C_{id} which is memorized in the user's electronic key 2, is transmitted to on-vehicle enabling device 4, and is subsequently processed and recognized to enable use of vehicle 3 by the user by means of electronic key 2.

In actual use, electronic key 2 initially contains no enabling code C_{id} (though personal data Dₚₑᵣₛ may be assumed to be already memorized in known manner in memory 5). More specifically, personal data Dₚₑᵣₛ is assumed to be already memorized by computer 12 by means of specific application software (especially as regards, for example, the telephone directory, music, and similar).

To enable electronic key 2 to use vehicle 3, electronic key 2 is interfaced with computer 12 according to the characteristics of the key (USB or credit card type key).

The software of computer 12 then retrieves the single identification code Cᵥₑₕ of vehicle 3 (the code may already reside in the software, or may be entered manually, e.g. from the keyboard of computer 12, or may be received over a protected link to an internet data bank), and proceeds to generate an enabling code C_{id} by processing the input data. The enabling code C_{id} generated is then memorized in memory 5 of electronic key 2.

The above input data comprises the identification code Cᵥₑₕ of vehicle 3 and other information which may usefully be associated with the enabling code C_{id} generated by computer 12, such as a particular authorization level for use of vehicle 3.

For example, enabling code C_{id} may be associated with a limited time period or authorization for use of only some of the functions of vehicle 3. This is particularly useful in the case of car hire or company car fleets (for example, electronic key 2 may be enabled for only a particular time period or a given mileage, or an employee may be permitted use of the vehicle but not the on-vehicle entertainment facilities). Once the time period governing use of the vehicle or the set mileage runs out, the enabling code C_{id} is invalidated, and electronic key 2 is no longer enabled to use vehicle 3.

The software of computer 12 may advantageously employ a graphic menu system, by which the enabling code C_{id} can be memorized quickly and easily in electronic key 2 together with data relative to the authorization level for use of vehicle 3.

Whichever the case, the holder of electronic key 2 may be totally unaware of the enabling code C_{id} generating process, and, in particular, need not necessarily know the identification code Cᵥₑₕ of vehicle 3.

Generation of the enabling code C_{id} must of course be authorized by the owner of vehicle 3 or the management of the vehicle fleet, e.g. car hire firm, of which vehicle 3 forms part. Only when authorization is given, e.g. by means of a password system, can an enabling code C_{id} recognizable by vehicle 3 be memorized in electronic key 2.

For data transmission security reasons, enabling code C_{id} generated by computer 12 may advantageously be encrypted (in known manner), e.g. by means of a public key and a private key. Computer 12 in fact can generate a potentially unlimited number of encrypted enabling codes C_{id} from the same identification code Cᵥₑₕ of vehicle 3.

To prevent the transmitted code from being intercepted by radio receivers and used for subsequent access to vehicle 3, known strategies are used so that codes transmitted by radio differ at each use (“rolling code” technique).

To operate utilization system 1, the user of vehicle 3 first transmits the enabling code C_{id} in memory 5 by means of transmitter 6 of electronic key 2.

This may be done in either active or passive mode.

In active transmission mode, transmission is activated by the user, e.g. by pressing a key (not shown) on electronic key 2.

In passive transmission mode, transmission is activated as the holder of electronic key 2 approaches vehicle 3, e.g. by means of a known enabling system sensitive to electromagnetic fields.

Receiver 8 of on-vehicle enabling device 4 receives and sends the enabling code C_{id} to processing unit 9, which processes enabling code C_{id} and any associated data.

It should be pointed out that data can be transmitted by transmitter 6 to receiver 8 in any known manner, and in particular using any known data transmission protocol.

According to one aspect of the present invention, receiver 8 is conveniently designed to successfully receive data transmitted by transmitters 6 of various electronic keys 2, so that a single data transmission standard, common to various vehicle manufacturers, would be advantageous.

Given the above aspect of the invention, electronic key 2 is therefore universal by permitting use of any vehicle, after first programming an appropriate enabling code C_{id} obtained by processing the vehicle identification code Cᵥₑₕ.

If the enabling code C_{id} is already encrypted, processing unit 9 decrypts it to generate a decrypted code. More specifically, only processing unit 9 can decrypt the enabling code C_{id} transmitted by electronic key 2, e.g. by only the processing unit knowing the private key with which the enabling code was encrypted.

The decrypted code is then compared with the vehicle identification code Cᵥₑₕ by comparator 10, which generates a positive-value logic signal in the event of positive identification of the user.

The logic signal generated by the comparator commands actuator 11, which enables use of vehicle 3 by the user—in particular, enables the user to unlock the doors and turn on the engine—and adjusts the adjustable on-vehicle devices to the user's preference, which involves reading the personal data Dₚₑᵣₛ stored in memory 5 of electronic key 2.

Actuator 11 also enables use of the vehicle according to the authorization level associated with the enabling code C_{id} of electronic key 2, e.g. only for a given mileage or a given length of time.

At any time, the user may obviously alter the adjustable device settings made automatically on the basis of the data stored in electronic key 2.

For this reason, the vehicle may advantageously be equipped with memory means (not shown) connected operationally to electronic key 2 to memorize the latest settings in electronic key 2. The same memory means also memorize the personal data Dₚₑᵣₛ (or part of it) the first time the user uses electronic key 2.

The advantages of the present invention will be clear from the foregoing description.

In particular, the electronic key according to the invention is obviously fully independent of any particular vehicle or vehicle identification code, by being reprogrammable. Once programmed, in fact, the key permits use of a potentially unlimited number of vehicles, by simply memorizing in the electronic key a new enabling code obtained by processing the identification code of any vehicle.

The user can therefore use any vehicle by means of a single personal electronic key, complete at all times with personal preference and setting data.

At any given time, the same electronic key may also be enabled to use a number of vehicles, each with a different authorization level, which may be associated with the relative enabling code.

In short, the electronic key becomes personal, by relating to the user as opposed to a given vehicle, and universal, by permitting use of any vehicle by simply memorizing an appropriate enabling code in the electronic key.

The utilization system according to the invention also facilitates running vehicle fleets easily and efficiently.

Moreover, the user need not replace the personal key when purchasing a new vehicle or, for any reason, using a vehicle other than his/her own.

Vehicle access is also simplified in the event the personal key is lost. In which case, the user need simply report the vehicle data to an authorized dealer; on the basis of the vehicle data, the vehicle identification code can be traced by data bank access; and an enabling code obtained by processing the identification code can simply be memorized in a “virgin” electronic key.

Clearly, changes may be made to the system as described and illustrated herein without, however, departing from the scope of the present invention as defined in the accompanying claims.

In particular, the electronic key according to the invention may obviously be of any form and structure other than those described.

Though the above description is based entirely on wireless communication between the electronic key and on-vehicle enabling device, connecting means may be used to interface the electronic key with the on-vehicle enabling device (e.g. in the form of a connector for insertion of the electronic key), in which case data is transmitted by electric contacts. In this case, the on-vehicle connecting means may conveniently be universal, i.e. for interfacing any electronic key. And again, a single standard employed by different vehicle manufacturers may be advantageous.

1. A vehicle utilization system permitting use of a vehicle having a respective identification code Cᵥₑₕ, the system comprising:
a key having memory means for storing an enabling code C_{id} enabling use of said vehicle; and
enabling means for permitting use of said vehicle by a user in possession of said key if the enabling code C_{id} stored in the key meets predetermined conditions,
characterized in that the system comprises programming means for generating the enabling code C_{id} as a function of the identification code Cᵥₑₕ of the vehicle, and for storing said enabling code in said key.

2. A system as claimed in claim 1, wherein said key is a personal key of said user.

3. A system as claimed in claim 1, wherein said key is a universal key.

4. A system as claimed in claim 1, wherein said enabling means comprise reading means for reading the enabling code C_{id} stored in said key.

5. A system as claimed in claim 1, wherein the memory means store a plurality of enabling codes C_{id}, each of said enabling codes being associated with a different vehicle usable by said user by means of said key.

6. A system as claimed in claim 1, wherein the programming means generate a plurality of different enabling codes C_{id} as a function of the same identification code Cᵥₑₕ.

7. A system as claimed in claim 1, wherein the vehicle has one or more adjustable devices, and said memory means store personal data Dₚₑᵣₛ relative to personal settings of the one or more adjustable devices, said personal data Dₚₑᵣₛ being read by the enabling means to activate adjustment of at least one of the one or more adjustable devices.

8. A system as claimed in claim 7, wherein the one or more adjustable devices comprise at least one device selected from the group consisting of an automatic driver's seat, an air conditioning system, an automatic rear-view mirror, a car radio, a satellite navigation system, and a cellular communication system.

9. A system as claimed in claim 1, wherein the programming means comprise setting means for setting an authorization level for use of the vehicle, said setting means associating with the enabling code C_{id} additional data relative to the set authorization level, and wherein said enabling means permit use of the vehicle by said user in accordance with said additional data.

10. A system as claimed in claim 1, wherein the key includes data transmission means for transmitting data comprising at least the enabling code C_{id}; and wherein the enabling means comprise data receiving means for receiving the data transmitted by said data transmission means; computing means for processing the received enabling code C_{id}; comparing means for comparing the processed enabling code C_{id} with the identification code Cᵥₑₕ; and actuating means responsive to said comparing means to enable use of the vehicle if the processed enabling code C_{id} matches the identification code Cᵥₑₕ.

11. A system as claimed in claim 10 wherein the response of the actuating means to the comparing means (10) comprises unlocking at least one door of the vehicle and start-up of an engine thereof.

12. A system as claimed in claim 11, wherein the vehicle has one or more adjustable devices; and said memory means store personal data Dₚₑᵣₛ relative to personal settings of the one or more adjustable devices, said personal data Dₚₑᵣₛ being read by the enabling means to activate adjustment of the one or more adjustable devices, and wherein the response of the actuating means further comprises adjusting at least one of the adjustable devices.

13. A system as claimed in claim 12, wherein the one or more adjustable devices comprise at least one device selected from the group consisting of an automatic driver's seat, an air conditioning system, an automatic rear-view mirror, a car radio, a satellite navigation system, and a cellular communication system.

14. A system as claimed in claim 10, wherein the programming means comprises encryption means for encrypting said enabling code C_{id}; and the computing means comprise decryption means for decrypting the received enabling code C_{id}.

15. A system as claimed in claim 14, wherein said encryption employs a public key and a private key.

16. A system as claimed in claim 10, wherein the data receiving means and the data transmission means comprise radio-frequency means.

17. A system as claimed in claim 1, wherein the programming means are implemented in a Personal Digital Assistant (PDA).

18. A system as claimed in claim 1, wherein the key is in the form of a USB key.

19. A key for a vehicle utilization system as claimed in claim 1.
